(19) United States
(12) Patent Application Publication
(10) Pub. No.: US 2026/0037103 A1
(43) Pub. Date: Feb. 5, 2026

(54) SYSTEMS AND METHODS FOR GENERATING GEOGRAPHIC AND TIME BOUNDED ITINERARIES

(71) Applicant: Airbnb, Inc., San Francisco, CA (US)

(72) Inventor: Vivek Tiwari, San Francisco, CA (US)

(73) Assignee: Airbnb, Inc., San Francisco, CA (US)

(21) Appl. No.: 19/287,574

(22) Filed: Jul. 31, 2025

Related U.S. Application Data
(60) Provisional application No. 63/677,512, filed on Jul. 31, 2024.

(51) Int. Cl. G06F 3/0482

(52) U.S. Cl. CPC G06F 3/0482

(57) ABSTRACT

Systems and methods for generating geographic and time bounded data objects are disclosed. A route object is obtained based on a received target geographic location and a location transition period. The route object includes a set of points of interest. A route between each point of interest is determined and a first geospatial search is implemented along the route to identify a set of first selectable objects. A selection of at least one first selectable object is received via the first graphical interface. A second geospatial search is implemented to identify a set of second selectable objects each associated with one of the points of interest. A selection of at least one second selectable object is received via a second graphical interface. A data object including the at least one route object, the at least one first selectable object, and the at least one second selectable object is generated.

### CROSS REFERENCE TO RELATED APPLICATIONS

This application claims benefit of U.S. Provisional Patent Application No. 63/677,512 filed Jul. 31, 2024, which is hereby incorporated by reference in its entirety for all purposes.

### TECHNICAL FIELD

This application relates generally to generating geographically bounded data objects, and more particularly, to generating geographic and time bounded data objects for presentation to a user.

### BACKGROUND

Some current systems allow a user to interact with an interface to select products or services within selected geographic regions. For example, certain existing interfaces allow a user to select lodging within a selected geographic area. As another example, certain existing interfaces allow a user to select and purchase access to activities within a selected geographic area. However, existing systems require a user to perform extensive planning and searching in order to build a cohesive set of geographically located selections. Current systems additionally require users to interact with multiple different interfaces to generate a set of geographically located selections.

### SUMMARY

In various embodiments, a system for generating geographic and time bounded data objects is disclosed. The system includes a non-transitory memory and a processor communicatively coupled to the non-transitory memory. The processor is configured to read a set of instructions to receive a target geographic location and a location transition period and obtain at least one route object based on the target geographic location and the location transition period. The at least one route object includes a set of points of interest. The processor is further configured to read the set of instructions to determine a route between each point of interest in the set of points of interest, implement a first geospatial search along the route to identify a set of first selectable objects, generate a first graphical interface including a graphical representation of the set of points of interest, the route, and the set of first selectable objects, receive a selection of at least one first selectable object via the first graphical interface, implement a second geospatial search to identify a set of second selectable objects each associated with one of the points of interest, generate a second graphical interface including a graphical representation of the set of points of interest and the set of second selectable objects, receive a selection of at least one second selectable object via the second graphical interface, and generate a data object comprising the at least one route object, the at least one first selectable object, and the at least one second selectable object.

In various embodiments, a computer-implemented method for generating geographic and time bounded data objects is disclosed. The computer-implemented method includes steps of receiving a target geographic location and a location transition period and obtaining at least one route object based on the target geographic location and the location transition period. The at least one route object includes a set of points of interest. The computer-implemented method further includes the steps of determining a route between each point of interest in the set of points of interest, implementing a first geospatial search along the route to identify a set of first selectable objects, generating a first graphical interface including a graphical representation of the set of points of interest, the route, and the set of first selectable objects, receiving a selection of at least one first selectable object via the first graphical interface, implementing a second geospatial search to identify a set of second selectable objects each associated with one of the points of interest, generating a second graphical interface including a graphical representation of the set of points of interest and the set of second selectable objects, receiving a selection of at least one second selectable object via the second graphical interface, and generating a data object comprising the at least one route object, the at least one first selectable object, and the at least one second selectable object.

In various embodiments, a non-transitory computer-readable medium having instructions stored thereon is disclosed. The instructions, when executed by at least one processor, cause at least one device to perform operations including receiving a target geographic location and a location transition period and obtaining at least one route object based on the target geographic location and the location transition period. The at least one route object includes a set of points of interest. The instructions further cause the at least one device to perform operations including determining a route between each point of interest in the set of points of interest, implementing a first geospatial search along the route to identify a set of first selectable objects, generating a first graphical interface including a graphical representation of the set of points of interest, the route, and the set of first selectable objects, receiving a selection of at least one first selectable object via the first graphical interface, implementing a second geospatial search to identify a set of second selectable objects each associated with one of the points of interest, generating a second graphical interface including a graphical representation of the set of points of interest and the set of second selectable objects, receiving a selection of at least one second selectable object via the second graphical interface, and generating a data object comprising the at least one route object, the at least one first selectable object, and the at least one second selectable object.

### BRIEF DESCRIPTION OF THE DRAWINGS

The features and advantages of the present invention will be more fully disclosed in, or rendered obvious by, the following detailed description of the preferred embodiments, which are to be considered together with the accompanying drawings wherein like numbers refer to like parts and further wherein:

FIG. 1 illustrates a network environment configured to generate geographically bounded data objects, in accordance with some embodiments;

FIG. 2 illustrates a computer system configured to implement one or more processes, in accordance with some embodiments;

FIG. 3 is a flowchart illustrating a geographic and time bounded object generation method, in accordance with some embodiments;

FIG. 4 is a block diagram illustrating portions of a system configured to implement one or more steps of the geographic and time bounded object generation method of FIG. 3, in accordance with some embodiments;

FIG. 5 illustrates an exemplary user interface, in accordance with some embodiments;

FIG. 6 illustrates a block diagram of portions of the system of FIG. 4 including a representative database having a plurality of route objects stored therein, in accordance with some embodiments;

FIG. 7 is a flowchart illustrating a method of selecting one or more selectable first objects, in accordance with some embodiments;

FIG. 8 illustrates a graphical user interface including graphical elements corresponding to POIs of a select route object, in accordance with some embodiments;

FIG. 9 is a flowchart illustrating a method of selecting one or more selectable first objects, in accordance with some embodiments; and

FIGS. 10A-10C illustrate exemplary user interfaces, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with,” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for generating geographic and time bounded data objects. In one non-limiting embodiment, a system receives location transition parameters including a target geographic location and a temporal period. The target geographic location may include a specific geographic location (e.g., GPS coordinates, street address, etc.) and/or a general geographic location (e.g., Seattle, Washington). In some embodiments, the location transition parameters may be referred to as trip parameters. One or more route objects including a plurality of points of interest (POIs) associated with the target geographic location may be obtained. Route objects may be obtained from a database based on the target geographic location and/or may be generated based on the target geographic location. In some embodiments, the route object may be referred to as an itinerary object.

For example, in some embodiments, a radius for a geospatial search of POIs at and/or within the target geographic location is determined based on the temporal period. In some embodiments, the temporal period corresponds to a stay period at and/or within the geographic location. After determining an initial radius, a geospatial search is performed within the initial radius to identify POIs. If less than a predetermined number of POIs (e.g., below a threshold number) are identified, the search radius may be expanded and searching may be performed within the expanded search area. The search area may be iteratively increased by predetermined and/or calculated increments until the expanded search area contains at least the predetermined number of POIs (e.g., equal to or above a threshold number). An itinerary object (route object) may be generated including at least a subset of the identified POIs.

After obtaining one or more itinerary objects, a route is generated between each of the POIs in an itinerary object and a second geospatial search is performed based on the route to identify a first class of selectable objects, such as lodging objects. The search for the first class of selectable objects includes one or more additional constraints related to the identified POI within the geographic area. For example, in some embodiments, a set of the first class of selectable locations is identified based on geographic distance from at least one of the POIs of the corresponding itinerary object, based on user preferences related to the first class of selectable locations, and/or any other suitable search parameter. A selection of at least one of the first class of selectable objects is received. In some embodiments, a second class of selectable objects, such as experience objects, associated with one or more of the POIs of a corresponding itinerary object is identified. The second class of selectable locations may be identified based on one or more search constraints related to the identified POIs within the geographic area and one or more additional search parameters. The additional search parameters may include temporal parameters, user preferences related to the second class of selectable locations, and/or any other suitable search parameter. A geographic and time bounded data object (e.g., a trip data object) is generated by modifying a selected itinerary object to include the selected at least one of the first class of selectable objects and the selected set of the second class of selectable objects.

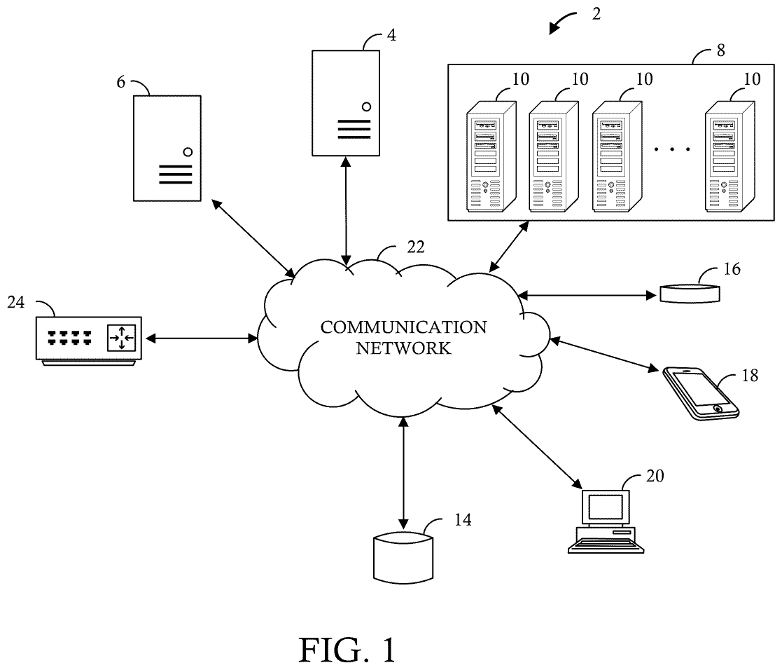

FIG. 1 illustrates a network environment 2 configured to provide generation of geographic and time bounded objects, in accordance with some embodiments. The network environment 2 includes a plurality of devices or systems configured to communicate over one or more network channels, illustrated as a network cloud 22. For example, in various embodiments, the network environment 2 may include, but is not limited to, an object generation computing device 4, a web server 6, a cloud-based engine 8 including one or more processing devices 10, a database 14, and/or one or more user computing devices 16, 18, 20 operatively coupled over the network 22. The object generation computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the object generation computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the object generation computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an online service booking network environment. In some embodiments, the object generation computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

Although FIG. 1 illustrates three user computing devices 16, 18, 20, the network environment 2 may include any number of user computing devices 16, 18, 20. Similarly, the network environment 2 may include any number of the object generation computing device 4, the web server 6, the processing devices 10, and/or the databases 14. It will further be appreciated that additional systems, servers, storage mechanisms, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the object generation computing device 4, the web server 6, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as an online booking website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view data for elements associated with and displayed on the website, and click on interface elements presented via the website. The website may capture these activities as user session data, and transmit the user session data to the object generation computing device 4 over the communication network 22. The website may also allow the user to interact with one or more of the interface elements to perform specific operations, such as selecting one or more elements for further processing.

In some embodiments, the object generation computing device 4 may execute one or more models, processes, or algorithms, such as a machine learning model, deep learning model, statistical model, etc., to generate geographic and time bounded objects. The object generation computing device 4 may transmit generated geographic and time bounded objects along with user interface parameters (e.g., instructions for representation of graphical elements corresponding to the generated geographic and time bounded objects) to the web server 6 over the communication network 22, and the web server 6 may display interface elements associated with the geographic and time bounded object and/or underlying elements of the geographic and time bounded object on the website to the user. For example, the web server 6 may display interface elements associated with points of interest, a first class of selectable objects, and/or a second class of selectable objects on a webpage, a window or interface of a chatbot, a search results interface, or a post-transaction webpage of the website (e.g., as the user browses those respective webpages).

The object generation computing device 4 is further operable to communicate with the database 14 over the communication network 22. For example, the object generation computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the object generation computing device 4, in some embodiments, the database 14 may be a local storage device, such as a hard drive, a non-volatile memory, or a USB stick. The object generation computing device 4 may store interaction data received from the web server 6 in the database 14. The object generation computing device 4 may also receive from the web server 6 user session data identifying events associated with browsing sessions, and may store the user session data in the database 14.

In some embodiments, the object generation computing device 4 generates training data for a plurality of models (e.g., machine learning models, deep learning models, statistical models, algorithms, etc.) based on aggregation data, historical data, search data, purchase data, catalog data, etc. The object generation computing device 4 and/or one or more of the processing devices 10 may train one or more models based on corresponding training data. The object generation computing device 4 may store the models in a database, such as in the database 14 (e.g., a cloud storage database).

The models, when executed by the object generation computing device 4, allow the object generation computing device 4 to generate one or more geographic and time bounded objects. For example, the object generation computing device 4 may obtain one or more models from the database 14. The object generation computing device 4 may then receive, in real time from the web server 6, a geographic location and time period. In response to receiving geographic location and time period, the object generation computing device 4 may execute one or more models to generate a geographic and time bounded object corresponding to the geographic location and time period.

In some embodiments, the object generation computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, the object generation computing device 4 may generate one or more geographic and time bounded objects for presentation via a graphical user interface.

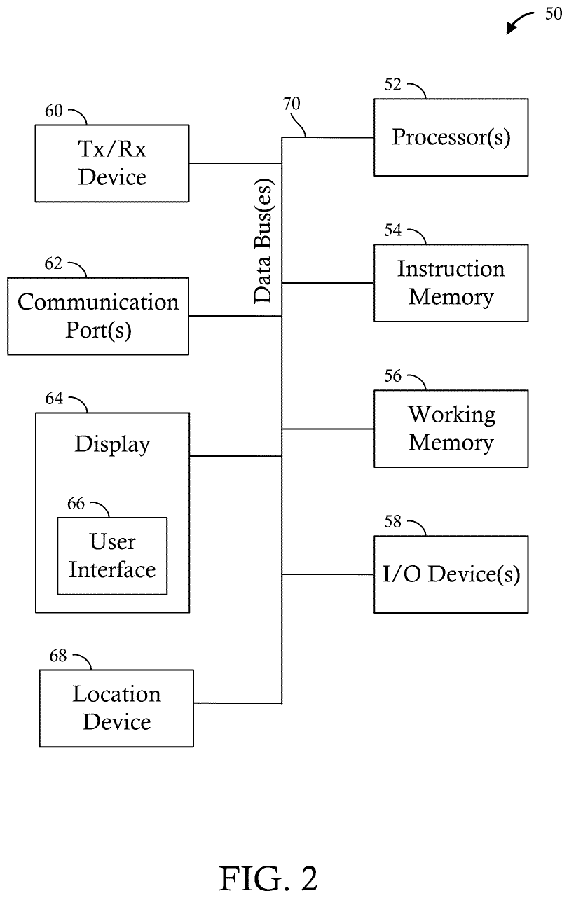

FIG. 2 illustrates a block diagram of a computing device 50, in accordance with some embodiments. In some embodiments, each of the object generation computing device 4, the web server 6, the one or more processing devices 10, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application-specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application-specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for generating geographic and time bounded objects, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communication protocols, services, or operating procedures. The communication port(s) 62 may include the appropriate physical connectors to connect with a corresponding communication medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allow for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fiber, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interface 66 may enable user interaction with selectable objects within a defined geographic area and within a defined temporal period. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application-specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that executes an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations and should generally not be limited to any particular implementation exemplified herein, unless such limitations are expressly called out. In addition, a module/engine may itself be composed of more than one sub-module or sub-engine, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

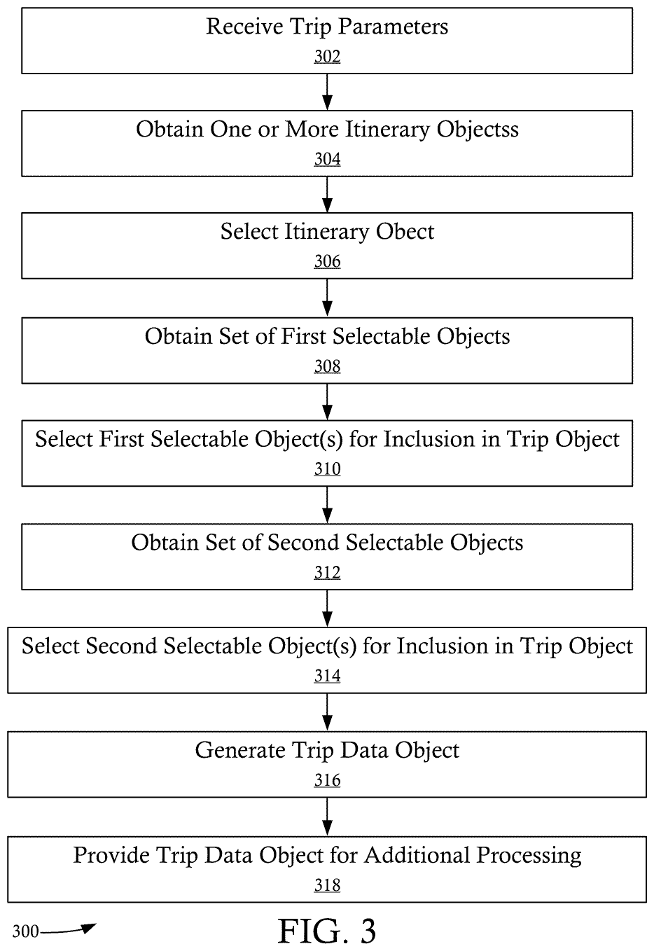

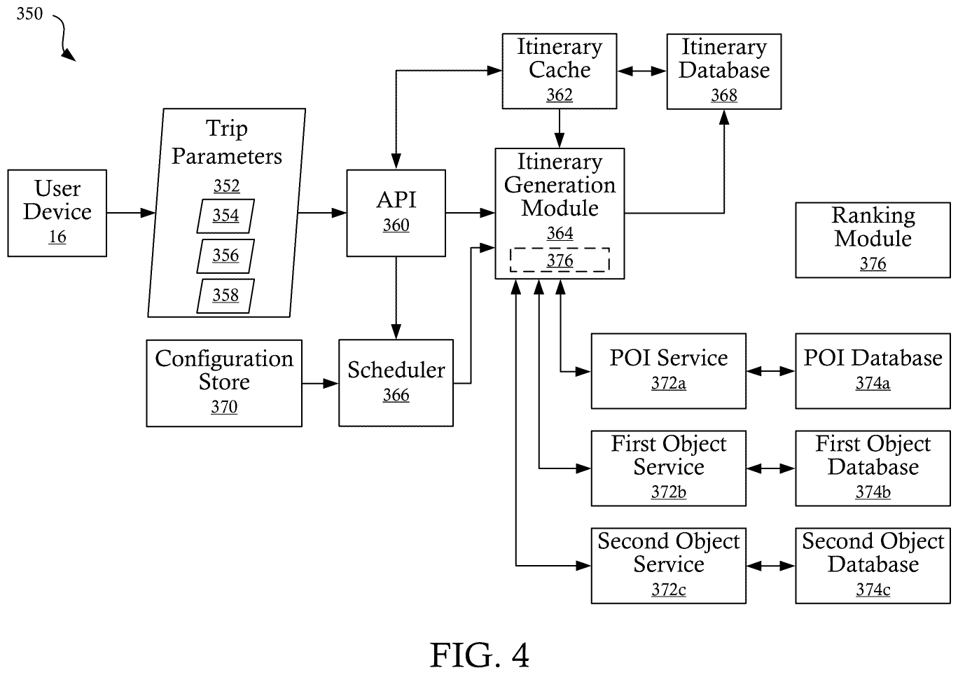

FIG. 3 is a flowchart illustrating a geographic and time bounded object generation method 300, in accordance with some embodiments. FIG. 4 is block diagram illustrating portions of a system 350 configured to implement one or more steps of the geographic and time bounded object generation method 300, in accordance with some embodiments. In some embodiments, the system 350 may generate geographic and time bounded objects along with user interface parameters (e.g., instructions for representation of graphical elements corresponding to the generated geographic and time bounded objects). At step 302, a set of trip parameters 352 is received. In some embodiments, the trip parameters 352 include a target geographic location 354, a travel period 356, and one or more additional parameters 358. It will be appreciated that references herein to the target geographic location 354, a travel period 356, one or more additional parameters 358, and/or other elements represented by data within the system 350 include references to the data as would be stored and/or utilized by the system 350. The target geographic location 354 identifies a geographic region and/or a geographic location. The target geographic location 354 may include a specific geographic location (such as a position indicated by a set of geospatial coordinates (e.g., global positioning system (GPS) coordinates, a position indicated by an address, and/or any other specific geographic location)) and/or a general geographic location (such as a geographic region (e.g., Pacific Northwest USA), a nation-state (e.g., France), a municipality (e.g., Seattle, Washington), etc.).

In some embodiments, the travel period 356 indicates a time period including a predetermined number of sub-periods. For example, the travel period 356 may include a predetermined number (e.g., 2, 3, 4, 5, etc.) of days, weeks, etc. The travel period 356 may include a fixed time period (e.g., a set of specific calendar dates defining the predetermined number of sub-periods) and/or may include a flexible time period (e.g., a target range of calendar dates having a first number of days and a travel period having a second number of days that is less than the first number of days). Although embodiments are discussed herein including consecutive, multiple-day travel periods, it will be appreciated that the disclosed systems and methods may be adapted to any suitable set of travel periods, including non-consecutive travel periods and/or travel periods consisting of larger or smaller sub-divisions.

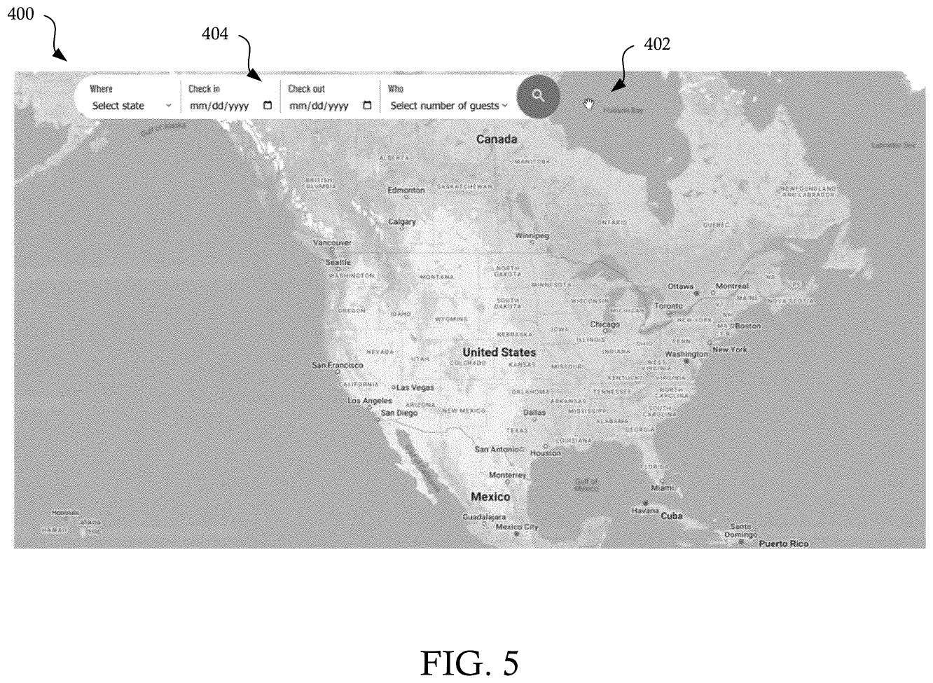

In some embodiments, the trip parameters 352 may be received via a graphical user interface, such as the graphical user interface 400 illustrated in FIG. 5. The graphical user interface 400 includes a graphical map element 402 and a trip parameters search bar 404. The graphical map clement 402 is representative of a general geographic search area encompassing multiple potential geographic location indicators. The trip parameters search bar 404 is configured to receive one or more trip parameters 352, such as, for example, a target geographic location 354, travel period 356 defined by a start (e.g., check-in) date and an end (e.g., check-out) date, additional parameters 358 (e.g., a guest number parameter), and/or any other suitable trip parameters. In some embodiments, the trip parameters 352 are received as a request set data structure including a target geographic location 354 data element and a travel period 356 defined by a start date data element and an end date data element. In some embodiments, the trip parameters 352 may be retrieved by analyzing a user input related to the user's desired location transition information in free format. The system 350 is configured to implement a Large Language Model (LLM) to process the user input including natural, conversational, or unstructured text and automatically generate the trip parameters 352. In some embodiments, the system 350 may configure a graphic user interface to receive the user input in free format instead of the trip parameters search bar 404.

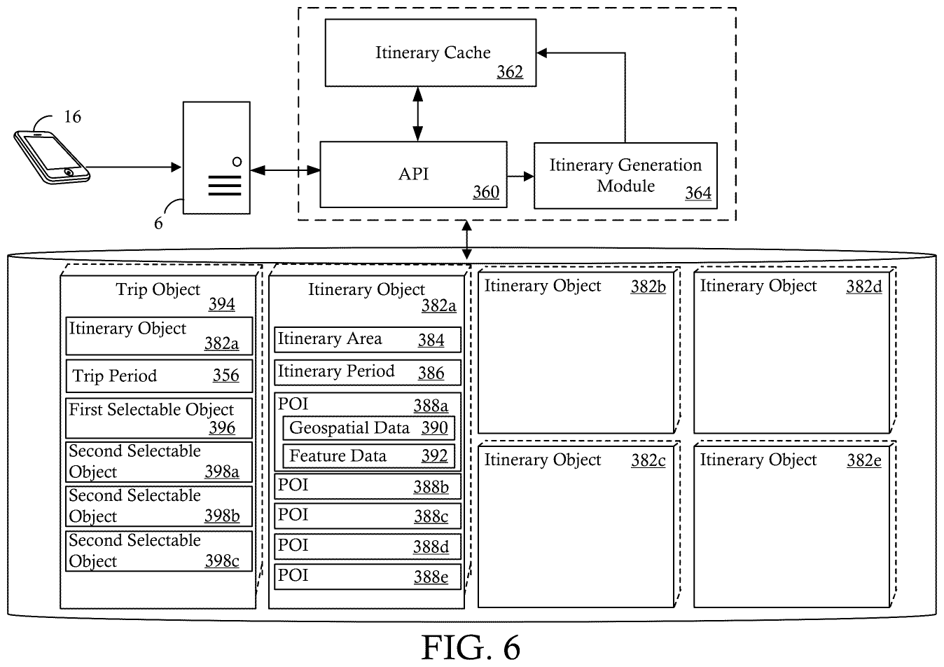

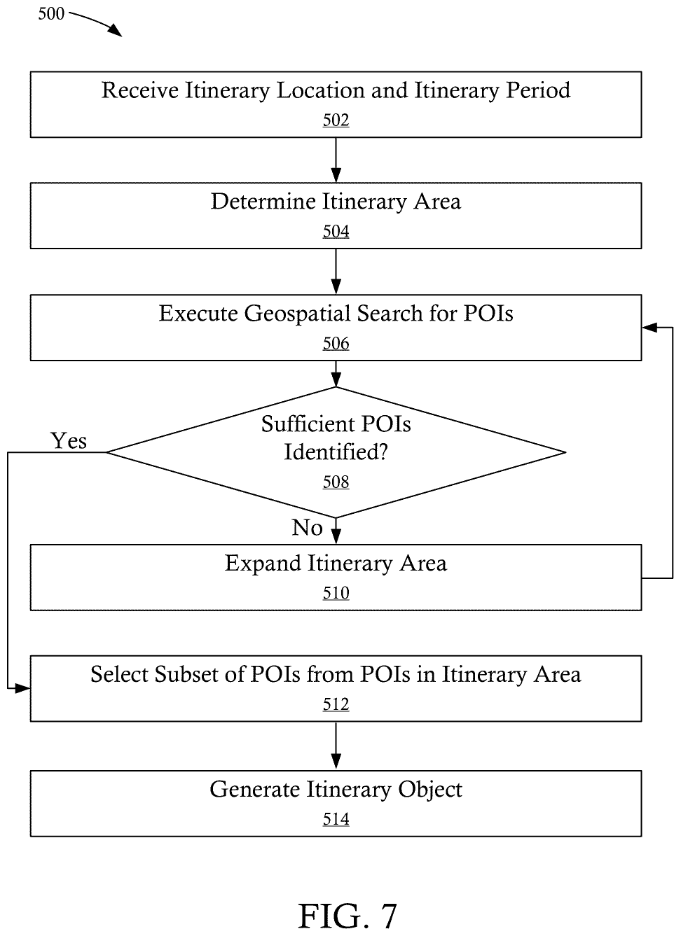

At step 304, one or more itinerary objects are obtained based on the received set of trip parameters 352. The one or more itinerary objects may be generated in real time based on the trip parameters 352 and/or may be pre-generated and obtained from a data storage (such as an itinerary cache 362 and/or an itinerary database 368) based on the trip parameters 352. FIG. 6 illustrates a block diagram of portions of the system 350 including a representative database 380 having a plurality of itinerary objects 382a-382c (collectively “itinerary objects 382”) stored therein, in accordance with some embodiments. Each of the itinerary objects 382 includes a set of POIs 388a-388e (collectively “POIs 388”) that are each located within a geographic area (e.g., itinerary area 384) associated with the itinerary object 382. In some embodiments, the itinerary area 384 may be referred to as a route area. In some embodiments, the itinerary cache 362 may be referred to as a route cache. In some embodiments, the itinerary database 368 may be referred to as a route database.

In some embodiments, when trip parameters 352 are received, such as via input in a graphical user interface such as interface 400, the trip parameters 352 are provided to a control interface, such as the application programming interface (API) 360. The API may be configured to obtain one or more itinerary objects 382 from an itinerary cache 362 storing pre-generated itinerary objects 382. For example, as discussed in greater detail below, a set of itinerary objects may be periodically generated and provided to an itinerary database 368 and loaded into an itinerary cache 362 in response to one or more inputs. In some embodiments, when an itinerary object matching the received trip parameters 352 is stored in the itinerary cache 362, the corresponding itinerary object is returned to the API 360. Alternatively, when an itinerary object matching the received trip parameters 352 is not stored in the itinerary cache 362, the itinerary cache 362 may request a corresponding itinerary object from the itinerary database 368 and/or cause generation of an itinerary object according to the trip parameters by the itinerary generation module 364.

In some embodiments, one or more itinerary objects 382 are generated by an itinerary generation module 364 in response to a set of trip parameters 352 received from a user device 16. For example, an itinerary object may be generated responsive to a determination that an itinerary object matching the trip parameters 352 is not stored in the itinerary cache 362 and/or the itinerary database 368. As another example, in some embodiments, the API 360 may be operated in a real-time generation mode in which one or more itinerary objects are generated for each received set of trip parameters. FIG. 6 illustrates a method 500 of generating itinerary objects which may be implemented by, for example, the itinerary generation module 364, in accordance with some embodiments.

At step 502, an itinerary geographic location and an itinerary period are provided to an itinerary generation module 364. An itinerary geographic location may include a specific geographic location or a general geographic location. In embodiments including generation of one or more real-time itinerary objects, the itinerary may be the target geographic location 354 and the itinerary period may be the travel period 356. Alternatively, in some embodiments, the itinerary generation module 364 may be operated periodically to pre-generate one or more itinerary objects for one or more target geographic locations and/or one or more time periods. In such embodiments, the itinerary geographic location and/or the itinerary period may be received from a configuration store 370. Periodic generation of itinerary objects may be triggered and/or controlled by a scheduler 366.

At step 504, an itinerary area 384 is determined based on the received itinerary geographic location and the itinerary period. The itinerary area 384 may be determined based on any suitable criteria, such as, for example, a distance from and/or within the itinerary geographic location, estimated travel time from and/or within the itinerary geographic location, predetermined geometric areas (e.g., circular, rectangular, etc.) having one or more dimensions related to the itinerary geographic location and/or the itinerary period, and/or any other suitable criteria. In some embodiments, an itinerary period may be referred to as a route period. In some embodiments, the itinerary area 384 may be based on the itinerary period. For example, a shorter itinerary period (e.g., three days) may correspond to a first area size (e.g., a first radius) for the itinerary area 384 and a longer itinerary period (e.g., five days) may correspond to a second area size (e.g. a second radius) for the itinerary area 384 that is larger than the first area size. In some embodiments, an itinerary arca 384 for a geographic location may be generated based on the number of days within an itinerary period, for example, by defining a radius of a circular area as r=days*N, where days is the number of days in the itinerary period and N is an integer selected based on the geographic location (e.g., 5, 10, 15, 20, 25, etc.). The integer value N may be selected based on an expected and/or maximum travel distance for the geographic location (e.g., a maximum expected travel distance for a given geographic location may be 100 miles per day and an integer value N of 15 may be selected to represent the overall travel within the itinerary area 384 for any given day of the itinerary). Although specific embodiments are discussed herein, it will be appreciated that any suitable heuristic, algorithm, process, etc. may be applied to determine an itinerary area 384.

For example, in some embodiments, an itinerary area 384 includes a circle having a radius determined based on the itinerary period established around a central point of the itinerary geographic location. When the itinerary geographic location indicates a specific geographic location (e.g., a set of geospatial coordinates), the central point may be set as the specific geographic location. As another example, when the itinerary geographic location includes a general geographic location (e.g., Seattle, Washington), a geographic center of the general geographic location may be used as the central point. The geographic center of a general geographic location may include a predetermined location and/or a calculated location. As another example, in some embodiments, an itinerary area 384 includes an area defined by a travel distance via one or more travel modalities from a central point of the itinerary geographic location.

In some embodiments, the itinerary area 384 may be partially based on one or more features of the itinerary geographic location. For example, an itinerary area 384 for a three-day itinerary period for a first geographic location, such as a city or other densely populated area, may be smaller as compared to an itinerary area 384 for a three-day itinerary for a second geographic location, such as a rural or sparsely populated area. Alternatively, an itinerary area 384 for a three-day itinerary period for a first geographic location with many modes of well-established transportation, such as a city or other densely populated area, may be larger as compared to an itinerary area 384 for a second geographic location lacking well-established infrastructure or only a single travel mode, such as a remote location. It will be appreciated that any number of features of a corresponding geographic location may be used to determine an itinerary area 384.

At step 506, a geospatial search is performed for POIs within an itinerary area 384. The geospatial search may be executed by a geospatial search engine implemented by a POI service 372a. The geospatial search engine may be configured to search a POI database 374a for POIs within the itinerary area 384. The POI database 374a includes a geospatial database configured to enable at least partial geospatial searching. The POIs may include any suitable locations within the itinerary area 384, such as museums, famous and/or historical locations, parks, activity centers, playgrounds, and/or any other location that may be of interest to one or more individuals.

In some embodiments, the geospatial search engine executes a search of the POI database 374a based on the itinerary area 384 and, optionally, a set of additional search parameters. In some embodiments, the set of additional search parameters includes user preferences indicative of types of POIs that are preferred by one or more users. User preference data may be obtained directly from a user and/or indirectly based on historical user interactions with a platform. As another example, in some embodiments, the set of additional search parameters may include theme, persona, and/or other generalized preferences indicative of types of POIs that correspond to general interests, such as a hiking persona, an outdoor theme, a family theme, a nightlife persona, etc. Each of the POIs may include geospatial data 390 enabling a geospatial portion of a search and one or more parameters or features 392 enabling use of the additional search parameters as part of the geospatial search. Although certain embodiments are discussed herein, it will be appreciated that any suitable additional search parameters may be used to limit the geospatial search.

In some embodiments, feature data 392 for a corresponding POI may be generated via one or more generative artificial intelligence (Gen-AI) models. For example, in some embodiments, a Gen-AI model may be configured to receive a data object representative of a point of interest including one or more of a title, description, reviews, etc., and generate corresponding search-enabling parameters for the point of interest from the received data object. The Gen-AI model may include, for example, a large language model configured to extract textual data related to the point of interest and generate a set of output tags related to the point of interest for indexing within the first geospatial database.

In some embodiments, the feature data 392 may include one or more temporal features indicating active periods during which the corresponding POI is selectable (e.g., open, available, etc.). The additional search parameters may include a time parameter indicating a specific time period, e.g., a travel period 356, for the geospatial search such that identified POIs are limited to only those POIs with a time feature indicating availability for the corresponding travel period 356. It will be appreciated that POIs may be added to and/or removed from the POI database 374a, may be updated to adjust one or more parameters such as temporal parameters, and/or otherwise may be updated such that a first geospatial search for POIs conducted at a first time for a first time period may produce a different set of POIs as compared to a second geospatial search conducted at a second time for the first time period or a second time period.

In some embodiments, the POIs are stored in the POI database 374a as data objects including at least a name data element defining a name of the POI, one or more location data elements (e.g., geospatial coordinates such as latitude and longitude) defining a location of the POI, one or more scores corresponding to the POI (e.g., a popularity score, an overall rating score, etc.), and/or any other suitable data. Although specific embodiments are discussed herein, it will be appreciated that the POIs may be stored in the POI database 374a using any suitable structure.

At step 508, a determination is made whether a sufficient number of POIs have been identified within the itinerary area 384. The determination may compare the number (M) of identified POIs to a threshold value (N) and determine that a sufficient number of POIs have been identified when M is equal to or greater than N. The threshold value (N) may be selected based on the itinerary period. For example, a first itinerary period (e.g., three days) may correspond to a first threshold value (N₁) and a second itinerary period (e.g., five days) may correspond to a second, higher threshold value (N₂) (e.g., N₂>N₁). In some embodiments, the threshold value (N) is selected based on a predetermined number of POIs to be included in each sub-period of an itinerary period. For example, in some embodiments, a predetermined number of POIs is required for each sub-period of an itinerary period (e.g., a set of Nₚ POIs for each sub-period) such that a total threshold value N for the itinerary period (N_{I}) is equal to the sum of the required number for each sub-period (e.g., N_{I}=X*N_{P}), where X is the number of sub-periods in the itinerary period. In some embodiments, the number of POIs per sub-period (e.g., N_{P}) is selected based on the itinerary area 384. When the number of POIs returned by the geospatial search is less than the threshold value (N), the method 500 proceeds to step 510. Alternatively, when the number of identified POIs is equal to or greater than the threshold value (N), the method 500 proceeds to step 512.

At step 510, when the geospatial search for the itinerary area 384 does not return a sufficient number of POIs, an expanded itinerary area 384 is generated by incorporating a larger geographic area. For example, in some embodiments, a radius of a circle defining the itinerary area 384 may be increased. The expanded itinerary area 384 may be generated by expanding an initial itinerary area 384 by a fixed amount (e.g., adding a fixed value to the radius of the itinerary area 384) and/or by a proportional amount (e.g., multiplying the radius of the itinerary area 384 by a proportional value). The increase to the itinerary area 384 may be based, at least in part, on the itinerary geographic location. For example, in some embodiments, a geographic location corresponding to a densely populated geographic area may have a smaller incremental increase applied as compared to a geographic location corresponding to a sparsely populated geographic area. After generating the expanded itinerary area 384, the method 500 returns to step 506 and performs a geospatial search within the expanded itinerary area 384. The method 500 may iteratively repeat steps 506-510 to search within an expanded itinerary area 384 and expand a prior itinerary area 384 until a sufficient number of POIs are identified (e.g., a number of POIs equal to or greater than a predetermined threshold value).

At step 512, a subset of POIs 388a-388e (collectively “POIs 388”) is selected from the POIs identified in the geospatial search for inclusion in an itinerary object 382a. The subset of POIs 388 may be selected randomly and/or based on or more criteria. For example, in some embodiments, the POIs returned by the geospatial search may be ranked according to one or more criteria (e.g., reviews, user preference criteria, location features, etc.) and the top P ranked POIs may be selected, where P is an integer greater than 1. As shown in FIG. 3, in some embodiments, the itinerary generation module 364 includes and/or is in communication with a ranking module 376 configured to apply one or more ranking processes to rank one or more elements, such as a first ranking process configured to rank identified POIs. As another example, in some embodiments, the POIs identified in the geospatial search may be filtered based on one or more criteria (e.g., keywords, tags, user preference criteria, etc.) and the subset of POIs 388 may be selected from the filtered set. Although specific embodiments are discussed herein, it will be appreciated that any suitable process may be applied for selecting a subset of the identified points of interest.

In some embodiments, the number of POIs 388 included in the itinerary object 382a is determined based on the itinerary period 386. For example, a first itinerary period (e.g., three days) may require selection of a first number of POIs and a second itinerary period (e.g., five days) may require selection of a second, higher number of points of interest. In some embodiments, the number of POIs 388 included in the itinerary object 382a is related to the number of sub-periods included in itinerary period 386. For example, itinerary period 386 may include one or more days and the POIs 388 may include a predetermined number of POIs for each of the days in the itinerary period 386.

In some embodiments, the number of POIs 388 included in the itinerary object 382a may vary based on one or more parameters of each of the selected POIs 388. For example, in some embodiments, each of the POIs 388 may include feature data 392 representative of a visit period defining an estimated or suggested time allotment for visiting the corresponding POI. POIs may include visit period variables defined in sub-periods corresponding to the sub-periods of the itinerary period 386 and/or further sub-divisions, such as providing a visit period in divisions of hours for an itinerary period 386 defined in days. The POIs 388 may be selected such that the total visit period for all of the selected POIs within a sub-period (e.g., one day) is less than a predetermined value. As one non-limiting example, where a sub-period of the itinerary period 386 is one day, the visit period for POIs may be provided in hours, and the subset of POIs 388 may be selected such that a sum of the visit period for all of the POIs 388 is less than or equal to 8 hours. Although specific embodiments are discussed herein, it will be appreciated that any suitable values may be used for the visit period variables and/or for the target total visit period.

In some embodiments, the total visit period for the POIs 388 may include one or more additional variables, such as estimated travel time, non-activity periods, buffer time, etc. The total visit period for the POIs 388 may further be adjusted based on the final size of the itinerary area 384. For example, if an itinerary area 384 was expanded one or more times during the geospatial search, the time allotted to each POI 388 may be increased and/or decreased to account for the increased travel distances and/or times between POIs.

In some embodiments, one or more designations may be applied to each of the POIs 388. For example, in some embodiments, a letter designation, e.g., “A,” “B,” “C,” etc., may be applied to each of the POIs 388. The designations may be applied randomly and/or according to one or more criteria. For example, in some embodiments, the one or more designations correspond to an order of expected visit for each of the POIs 388. As another example, in some embodiments, the one or more designations correspond to rankings of each of the individual POIs 388. It will be appreciated that any suitable criteria may be utilized to apply designations to the POIs 388.

At step 514, an itinerary object, such as itinerary object 382a, is generated. The itinerary object 382a includes the itinerary area 384, the itinerary period 386, and each of the POIs 388. The itinerary object 382a may be stored in an itinerary cache 362 and/or an itinerary database 368. The itinerary cache 362 and/or the itinerary database 368 may be configured to allow for geospatial searching of itinerary objects 382 to identify itinerary objects having itinerary areas 384 corresponding to target geographic locations 354.

In some embodiments, one or more additional data elements may be generated for an itinerary object 382a. For example, in some embodiments, an itinerary object title may be generated for a corresponding itinerary object 382a. The itinerary object title may be generated using any suitable process, such as, for example, a generative artificial intelligence process configured to generate a title based on the itinerary area 384, the itinerary period 386, the points of interest 388, and/or any other suitable data. As another example, in some embodiments, an itinerary object 382a may include an aggregated ranking generated based on rankings of each of the POIs 388 included in the itinerary object 382a. For example, an average, mean, weighted mean, etc. of the rankings of the POIs 388 may be generated and applied as a ranking of the corresponding itinerary object 382a. As yet another example, one or more classifications may be generated for an itinerary object. For example, in some embodiments, one or more tags may be generated for each itinerary object. The tags may include, for example, user interests and/or keywords associated with the itinerary objects.

As an additional example, in some embodiments, one or more insight data elements may be generated for an itinerary object 382a. Insight data elements may include, but are not limited to, data elements representative of comprehensive and/or itinerary-specific information, such as a total cost for a corresponding itinerary object 382a, a total activity time for a corresponding itinerary object 382a, a total travel time for a corresponding itinerary object 382a, a travel type for a corresponding itinerary object 382a, a sustainability value representative of the climate impact of the corresponding itinerary object 382a, etc. In some embodiments, the insight data elements may be presented in conjunction with one or more interfaces on a user interface, for example, as discussed in greater detail below.

With reference again to FIGS. 3-4, step 304 may be executed in real time and/or may be pre-executed at a predetermined interval. In some embodiments, one or more itinerary objects 382 may be generated for one or more itinerary areas 384 and one or more itinerary periods 386. For example, itinerary objects 382 corresponding to a first target geographic location (e.g., Seattle, Washington) and one or more itinerary periods (e.g., three days, four days, five days, etc.) may be generated periodically. The itinerary objects 382 may be generated without a travel period and/or for each corresponding travel period in one or more future time ranges (e.g., next X days, next X months, etc.). The periodically generated itinerary objects 382 may be stored in the itinerary database 368. When user-provided trip parameters 352 are received, the itinerary database 368 may be searched based on the user-provided trip parameters 352 to retrieve one or more previously generated itinerary objects 382 corresponding to the user-provided trip parameters 352.

In some embodiments, itinerary objects 382 may be pre-generated for one or more predetermined geographic locations and/or one or more predetermined itinerary periods. For example, in some embodiments, a set of itinerary objects is generated for a first geographic location for each of a plurality of itinerary periods (e.g., three days, four days, five days, etc.) and stored in the itinerary cache 362 and/or the itinerary database 368. In some embodiments, a scheduler 366 is configured to periodically schedule generation of itinerary objects for one or more predetermined geographic locations and/or one or more itinerary periods. The scheduler 366 may be in communication with a configuration store 370 configured to provide location-specific parameters for generation of itinerary objects. For example, the configuration store 370 may be configured to store an initial itinerary area radius for geographic locations, a radius multiplier for increasing the size of geographic locations, itinerary periods for corresponding geographic locations, etc.

In some embodiments, at least one itinerary object of itinerary objects 382 may be updated in accordance with a user input. For example, a system 350 may configure a graphical interface including a graphical representation of the itinerary objects 382. As explained above, each of the itinerary objects 382 may include a set of points of interest. The system 350 may receive a user input to modify the set of points of interest by removing at least one point of interest in the set of points of interest and/or adding at least one new point of interest. In some embodiments, the user input may include a user input in free format (e.g., natural, conversational, or unstructured text) and/or user touch gestures such as drag, tap, etc. In some embodiments, the system 350 is configured to implement a Large Language Model (LLM) to process the user input. Based on a reception/detection of the user input, the system 350 may automatically update a corresponding itinerary object and store the updated itinerary object. In some embodiments, the system 350 may automatically rearrange graphical elements for the updated itinerary objects 382 in the graphical interface in real time based on the determination of reception/detection of the user input.

After obtaining one or more itinerary objects, the method 300 proceeds to step 306, and a first itinerary object 382a is selected from the set of itinerary objects 382. The selected itinerary object 382a may be selected based on a user interaction with a graphical user interface, by an automated process based on one or more selection criteria, and/or responsive to one or more additional inputs. For example, in some embodiments, a set of itinerary objects 382 may be presented as selectable interface objects via a graphical user interface. The itinerary objects 382 may be presented in a list form, a grid form, carousel form, and/or in any other suitable format on the graphical user interface. A user may select one of the presented itinerary objects 382 based on the points of interest included within the corresponding itinerary object 382, one or more tags associated with the presented itinerary objects 382, one or more ratings associated with the presented itinerary objects 382, and/or any other suitable criteria. As another example, in some embodiments, an automated process may select an itinerary object utilizing one or more selection criteria, such as, for example, user preferences, system preferences, ratings, rankings, etc.

In some embodiments, the selected itinerary object 382a may be selected from a subset of the available itinerary objects 382. For example, in some embodiments, the available itinerary objects 382 may be ranked and/or filtered based on one or more criteria, such as, for example, reviews of the itinerary objects 382 and/or reviews of POIs 388 included in the corresponding itinerary object 382a; tags, keywords, or other identifiers associated with the itinerary objects 382; etc. A filtered subset of the available itinerary objects 382 may be provided via the graphical user interface and/or as inputs to an itinerary selection process, and the selected itinerary object 382a may be selected from the filtered subset.

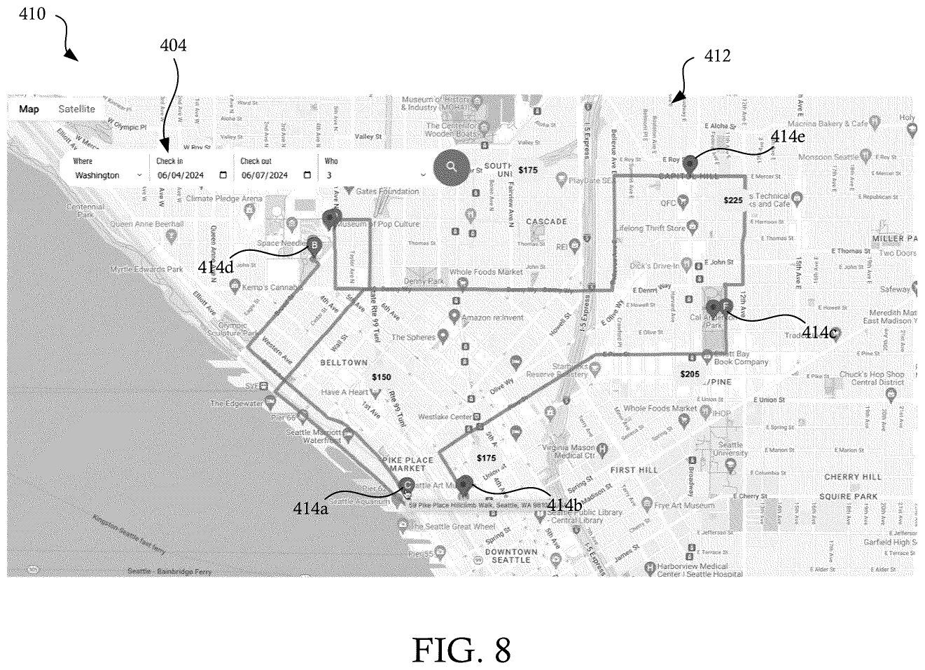

FIG. 8 illustrates a graphical user interface 410 including graphical elements 414a-414e corresponding to POIs of a select itinerary object, in accordance with some embodiments. The graphical user interface 410 includes a graphical element 412 representative of at least a portion of an itinerary area 384. For example, in some embodiments, the graphical element 412 is representative of the entire itinerary area 384 and/or a portion thereof containing POIs included in the itinerary object. In some embodiments, the graphical user interface 410 is configured to display identified POIs within the itinerary area 384 and to allow user interaction to select one or more of the POIs.

In some embodiments, the graphical user interface 410 may be configured to display additional information and/or data objects related to one or more selected itinerary objects 382. For example, in some embodiments, the graphical user interface 410 is configured to display insight data elements in conjunction with one or more selected itinerary objects 382. As discussed above, insight data elements may be configured to provide comprehensive and/or itinerary-specific information to a user. The insight data elements may be selected to provide useful information to a user to assist the user in selecting an itinerary object from the graphical user interface 410.

At step 308, a set of selectable first objects is selected for presentation in conjunction with a selected itinerary object. The selectable first objects include elements selectable by a user that have time and location parameters corresponding to the target geographic location 354 and the travel period 356. For example, in some embodiments, the selectable first objects include lodging objects representative of lodging locations having corresponding availability for the travel period 356 and that are located near and/or within the target geographic location 354. Although specific embodiments are discussed herein, it will be appreciated that the first selectable objects may include any suitable objects having corresponding time and location parameters.

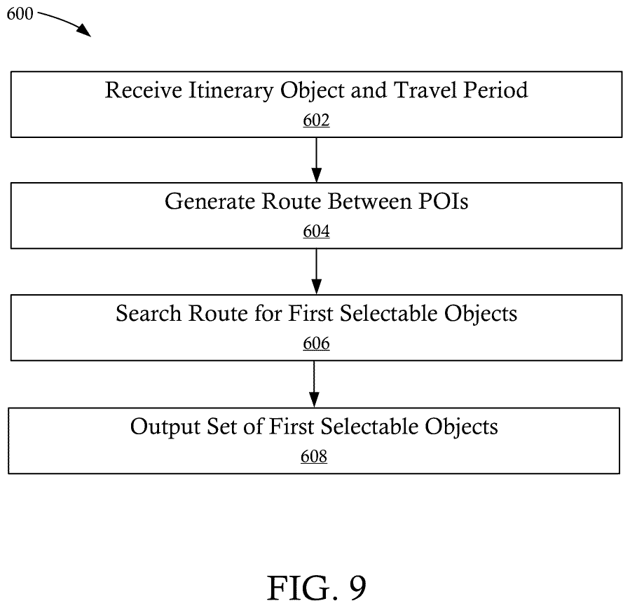

FIG. 9 is a flowchart illustrating a method 600 of selecting one or more selectable first objects, in accordance with some embodiments. The method 600 may be executed by any suitable process and/or module, such as a first selectable object service 372b. At step 602, an itinerary object, such as itinerary object 382a, and a travel period 356 are received. As discussed above, the itinerary object 382a includes one or more POIs 388 identified within an itinerary area 384. The itinerary object 382a may be a user-selected itinerary object and/or a system-selected itinerary object. The travel period 356 may include a selected calendar date range having a number of days corresponding to the itinerary period 386 of the received itinerary object 382a.

At step 604, at least one route (e.g., path) is generated between the POIs 388 included in the itinerary object 382a. A route may be generated between the POIs 388 randomly and/or based on one or more path criteria. For example, in some embodiments, a travel path for a first mode of travel (e.g., car travel, bike travel, foot travel, etc.) between each of the POIs 388 is generated. The travel path may be generated according to one or more additional constraints, such as user preferences regarding travel (e.g., avoiding toll rolls while traveling via car), traffic information, etc.

In some embodiments, a route between two or more POIs is represented as a graph including node locations for each of the corresponding POIs and edges connecting each of the nodes. The edges may be representative of travel modalities and/or travel paths. The travel paths between each POI may be randomly selected and/or may be generated based on one or more criteria, such as, for example, proceeding from a highest-ranked POI to a lowest-ranked POI, first object data associated with each POI corresponding to features of first selectable objects associated with each of the POIs, and/or any other suitable information. In some embodiments, the route between each of the POIs may be optimized for one or more parameters, although it will be appreciated that optimized routes may not be preferred in some embodiments.

At step 606, geospatial and time feature searching is performed along the at least one route to identify first selectable objects associated with the route. For example, in some embodiments, a route traversal search method is implemented to traverse the generated route and identify first selectable objects on and/or within a predetermined distance of the generated route within a first selectable object database 374b. As another example, a geospatial search may be executed within a geographic area defined by the route and/or one or more variables (e.g., distance from route) within the first selectable object database 374b. The geospatial and time bounded search includes a time range search parameter corresponding to at least a portion of the travel period 356. For example, in some embodiments, the time range search parameter includes the entire travel period defined by the travel period 356 and/or a predetermined sub-period (e.g., day) within the travel period 356. Thus, the geospatial and time bounded search is configured to identify first selectable objects (e.g., lodging objects) located on a generated route determined by and that are available for selection during the time period defined by the travel period 356.

In some embodiments, the geospatial search is further limited according to one or more additional first object search parameters. The additional first object search parameters may include one or more non-geospatial search parameters related to the first selectable objects, such as, for example, user preferences related to the first selectable objects, parameters related to the first selectable objects, etc. As one non-limiting example, in embodiments including lodging objects as the first selectable objects, the first object search parameters may include, but are not limited to, user lodging preferences (e.g., user preferences related to types of lodging, pricing of lodging, preferred locations, proximity to POIs and/or other locations, etc.). The user preference data may be provided directly by a user and/or generated from user historical information related to prior interactions with a network platform.

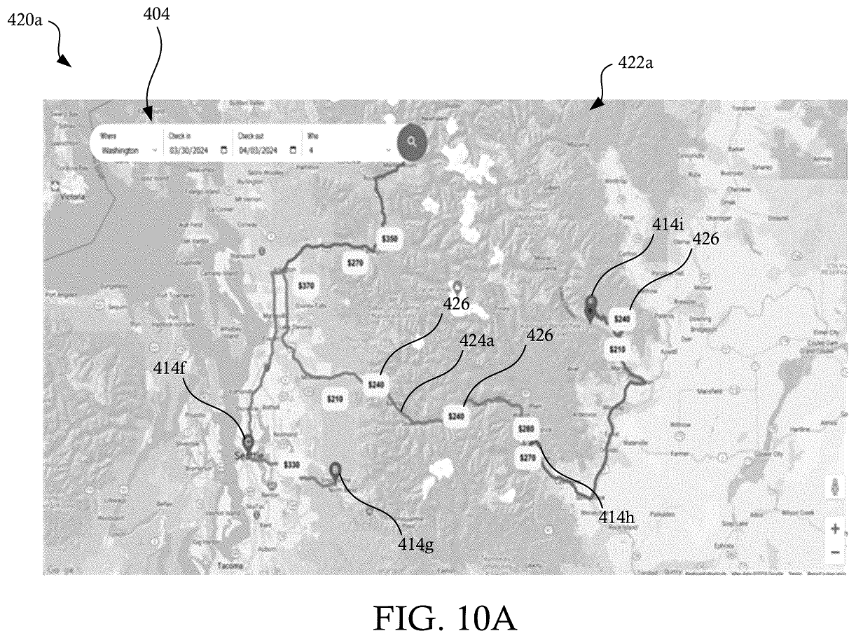

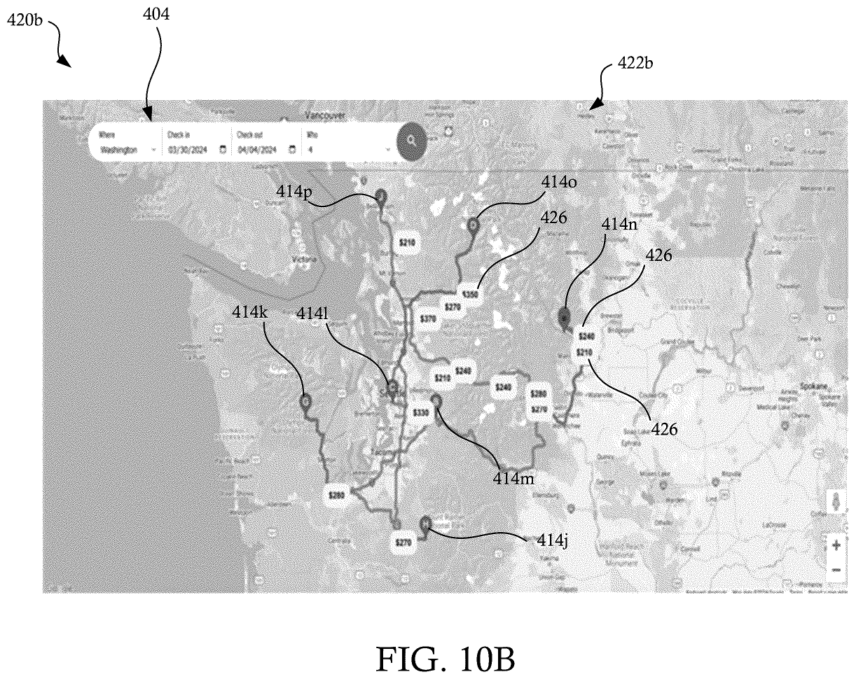

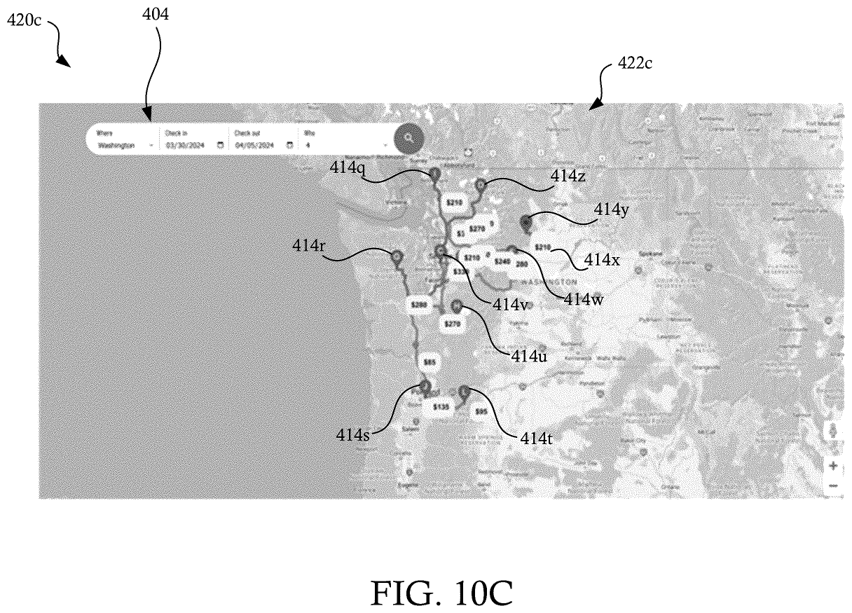

At step 608, a set of first selectable objects is output for inclusion in a graphical user interface to be presented to a user in conjunction with at least a portion of the itinerary object 382a. For example, as illustrated in FIGS. 10A-10C, a graphical user interface 420a-420c may be generated including graphical elements 422a-422c representative of at least a portion of a target geographic location 354. The graphical elements 422a-422c may include a visual map of at least a portion of the target geographic location 354. The graphical user interfaces 420a-420c include graphical representations 424a-424c of at least one of the routes determined at step 604 and a set of first interface elements 426. In some embodiments, the first interface elements 426 are displayed in conjunction with a set of POI interface elements 414f-414z representative of POIs of a corresponding itinerary object. In some embodiments, each of the first interface elements 426 are configured to display one or more features of the corresponding POI. For example, in the illustrated embodiments, an average price feature is displayed as part of each first interface element 426. Each of FIGS. 10A-10C corresponds to an itinerary object generated for a target geographical location of “Washington State” and a corresponding itinerary period (e.g., FIG. 10A is representative of an itinerary object having an itinerary period of four days, FIG. 10B is representative of an itinerary object having an itinerary period of five days, and FIG. 10C is representative of an itinerary object having an itinerary period of six days). As shown in FIGS. 10A-10B, as the number of sub-periods (e.g., days) in an itinerary object increases, the number of POIs and/or the number of first selectable objects illustrated in conjunction with the POIs increases.

In some embodiments, the output first selectable objects include data objects containing a plurality of predefined data elements. For example, in some embodiments, each of the output first selectable objects may include, but are not limited to, a data structure including a name data element defining a name of the corresponding first selectable object, a location data element (such as geospatial data or general location data) providing a corresponding location, a price element defining a price for selection of the first selectable object, one or more image elements including images representative of the first selectable object, one or more feature elements defining feature values for a predetermined set of features associated with the first selectable objects, review elements including a review score and one or more reviews for the corresponding first selectable object, an overall rating element, and/or any other suitable data elements.

With reference again to FIGS. 3-4, at step 310, at least one first selectable object 396 is selected from a presented set of selectable objects for inclusion in a generated trip data object 394. The at least one first selectable object 396 may be selected by a user via a graphical user interface (such as the graphical user interfaces 420a-420c discussed above), selected based on one or more criteria from a set of first selectable objects (e.g., a highest-ranked first selectable object based on one or more ranking criteria), and/or may be selected randomly from a set of selectable objects. In some embodiments, two or more first selectable objects may be selected from a set of selectable first objects. Each of the selected first selectable objects 368a, 368b may be selected for a sub-portion of the travel period defined by the travel period 356.

At step 312, a set of selectable second objects is selected for presentation in conjunction with a selected itinerary object. The selectable second objects include elements selectable by a user that have location parameters corresponding to one of the POIs 388 of a selected itinerary object. For example, in some embodiments, the selectable second objects include experience objects representative of activities, events, etc. at and/or associated with a POI and that have corresponding availability for the travel period 356. Although specific embodiments are discussed herein, it will be appreciated that the second selectable objects may include any suitable objects having corresponding time and location parameters.

In some embodiments, the set of second selectable objects is generated by a geospatial and/or time-based search implemented by a second selectable object service 372c configured to search a second selectable object database 374c. The geospatial features of the search may identify second objects that are associated with (e.g., have the same and/or similar geolocation as) at least one of the POIs of a selected itinerary object. In some embodiments, each of the second selectable objects includes a POI indicator referencing a nearest and/or associated POI. The second selectable object database 374c may be searched to identify second selectable objects having a feature indicating association with at least one of the POIs 388 of a selected itinerary object. Although specific embodiments are discussed herein, it will be appreciated that any suitable search method and/or selection process may be applied to identify second selectable objects.

In some embodiments, each second selectable object includes a data object containing a plurality of predefined data elements. For example, in some embodiments, a second selectable object includes data elements such as a name element defining a name of the corresponding second selectable object (e.g., experience), a location data element (such as geospatial data or general location data) providing a corresponding location, a price element defining a price for selection of the second selectable object, one or more image elements including images representative of the second selectable object, one or more experience elements including information corresponding to the second selectable object, review elements including a review score and one or more reviews for the corresponding second selectable object, an overall rating clement, and/or any other suitable data elements. For example, the second selectable object represents a bookable experience, event, activity or service.

In some embodiments, the set of selectable second objects may be updated in accordance with a user input. For example, a system 350 may receive a user input to modify the set of selectable second objects by removing at least one second object and/or adding at least one new second object. In some embodiments, the user input may include a user input in free format (e.g., natural, conversational, or unstructured text) and/or user touch gestures such as drag, tap, etc. In some embodiments, the system 350 is configured to implement a Large Language Model (LLM) to process the user input. Based on a reception/detection of the user input, the system 350 may automatically update the set of selectable second objects and store the updated set of selectable second objects. In some embodiments, the system 350 may automatically rearrange graphical elements for the updated set of selectable second objects in the graphical interface based on the determination of receiving the user input in real time. In some embodiments, the system 350 may control color-coding which is applied to a graphical element for the updated second object in the graphical interface. In some embodiments, the color-coding may include variations in border color, text color or highlight overlay to visually distinguish the updated second object and the remaining second objects. For example, the graphical element for the updated second object may be color-coded using a predefined color (e.g., red), while graphical elements for the remaining second objects may appear in a default color.

At step 314, at least one second selectable object 398a-398c is selected from a presented set of selectable objects for inclusion in a generated trip data object 394. The set of second itinerary objects 398a-398c may be selected based on user interactions with a graphical user interface (e.g., user selections received via a graphical user interface such as the graphical user interfaces 420a-420c discussed above), based on one or more applied criteria (e.g., user preferences, system preferences, etc.), and/or based on any other suitable parameters. The set of second itinerary objects 398a-398c may be incorporated into a trip data object 394 and/or referenced by the trip data object 394.

At step 316, a geographic and time bounded data object (e.g., trip data object 394) is generated. The trip data object 394 includes an itinerary object 382a, including the POIs 388 associated therewith, the at least one first selectable object 396, and the set of second selectable objects 398a-398c. The trip data object 394 may be generated by modifying the itinerary object 382a and/or may be generated by incorporating data associated with the itinerary object 382, the at least one first selectable object 396, and the set of second selectable objects 398a-398c into a newly generated data structure. The trip data object 394 may be stored in any suitable storage mechanism, such as, for example, one of the geospatial databases discussed herein.

At step 318, the trip data object 394 is utilized for one or more additional processes. For example, in some embodiments, the trip data object 394 is provided for use in one or more checkout processes in which the at least one first selectable object 396 and/or the set of second selectable objects 398a-398c are reserved and/or booked for use by a user. As another example, in some embodiments, the trip data object 394 may be provided for incorporation into and/or representation as part of a displayed graphical user interface for confirmation of selections and/or modification of previously selected elements. It will be appreciated that any suitable processing may be performed based on the generated trip data object 394. In some embodiments, a system 350 may periodically update at least one itinerary object in the trip data object based on the booking or reservation result and store the updated itinerary object in the itinerary cache 362. Such updated itinerary object may be used to generate one or more new itinerary objects 382. In some embodiments, a system 350 may control a display of the geographic and time bounded data object. For example, the system 350 may provide a graphical interface for the geographic and time bounded data object. The system 350 may receive a user input to organize each graphical element based on specific criteria. In some embodiments, the specific criteria may include a category of selectable object, the amount of use of each graphical element by a user, and reservation/booking result. In some embodiments, the system 350 may automatically detect/determine whether any user interaction meets the specific criteria. The system 350 may automatically move/rearrange a location of at least one graphical element in the graphical interface based on the detection/determination. For example, the system 350 may automatically remove a graphical element for a selectable first object when a lodging corresponding to the selectable first object has been reserved by another user. For example, the system 350 may automatically adjust/control color-coding of at least one graphical element for selectable first object/selectable second object based on the amount of use of the at least one graphical element. If the at least one graphical element is the most frequently selected, used or interacted with the user (e.g., most frequently clicked), the system 350 may apply color-coding to the at least one graphical element using a predefined color or change a position of the at least one graphical element.

In some embodiments, systems and methods for generating geographic and time bounded data objects include one or more trained machine learning models. The trained machine learning models may include one or more models, such as ranking models, search models, generative models, etc.

In general, a trained function mimics cognitive functions that humans associate with other human minds. In particular, by training based on training data, the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

In some embodiments, a trained function may include a neural network, a support vector machine, a decision tree, a Bayesian network, a clustering network, Qlearning, genetic algorithms and/or association rules, and/or any other suitable artificial intelligence architecture. In some embodiments, a neural network may be a deep neural network, a convolutional neural network, a convolutional deep neural network, etc. Furthermore, a neural network may be an adversarial network, a deep adversarial network, a generative adversarial network, etc.

Identification of data elements incorporated into the disclosed geographic and time bounded data object can be burdensome and time-consuming for users, especially if different search platforms and/or interface platforms are required to be accessed for each type of element desired (e.g., different interfaces for points of interest, lodging objects, experience objects, etc.). Typically, a user may locate information regarding points of interest, lodging objects, and/or experience objects by interacting with disparate interfaces configured to provide certain information regarding only one of the objects. Such interface interactions typically require multiple interfaces and platforms to be utilized, requiring users to navigate through several levels of pages and to cross-reference different platforms to perform functions that incorporate each of the elements of a trip data object. Thus, the user frequently has to perform numerous navigational steps and utilize multiple pages to perform actions such as booking a lodging, booking one or more experiences, identifying points of interest within a target geographic area, etc.

Systems including generation of trip data objects, as disclosed herein, significantly reduce this problem, allowing users to build coherent trip data objects containing multiple required elements with fewer, or in some cases no, active steps. For example, in some embodiments described herein, when a user is presented with a result interface for a given target location and location transition period, each interface element includes, or is in the form of, a link to an interface page for a corresponding pre-generated itinerary object that may be used to select user-preferred lodging objects and/or experience objects. Each generated trip data object thus serves as a programmatically selected navigational shortcut to one or more additional action pages, allowing a user to bypass the navigational structure of multiple interfaces. Beneficially, programmatically identifying elements of a trip data object and presenting a user with navigational shortcuts to related tasks may improve the speed of the user's navigation through an electronic interface, rather than requiring the user to page through multiple other pages in order to locate the relevant information.

Although the subject matter has been described in terms of exemplary embodiments, it is not limited thereto. Rather, the appended claims should be construed broadly, to include other variants and embodiments, which may be made by those skilled in the art.

What is claimed is:

1. A system for generating geographic and time bounded data objects, comprising:
a non-transitory memory;
a processor communicatively coupled to the non-transitory memory, wherein the processor is configured to read a set of instructions to:
receive a target geographic location and a location transition period;
obtain at least one route object based on the target geographic location and the location transition period, wherein the at least one route object includes a set of points of interest;
determine a route between each point of interest in the set of points of interest;
implement a first geospatial search along the route to identify a set of first selectable objects;
generate a first graphical interface including a graphical representation of the set of points of interest, the route, and the set of first selectable objects;
receive a selection of at least one first selectable object via the first graphical interface;
implement a second geospatial search to identify a set of second selectable objects each associated with one of the points of interest;
generate a second graphical interface including a graphical representation of the set of points of interest and the set of second selectable objects;
receive a selection of at least one second selectable object via the second graphical interface; and
generate a data object comprising the at least one route object, the at least one first selectable object, and the at least one second selectable object.

2. The system of claim 1, wherein the processor is configured to obtain the at least one route object by reading the set of instructions to:
determine a route area based on a target geographic location and a route period based on the location transition period;
implement a third geospatial search to identify a set of points of interest within the route area;
when the set of points of interest includes less than a threshold number of points of interest determined based on the route period:
expand the route area;
implement a fourth geospatial search to identify a set of points of interest within the expanded route area;
select a subset of the set of points of interest for inclusion in the at least one route object; and
output the at least one route object including the subset of the set of points of interest, the route area, and the route period.

3. The system of claim 2, wherein the route area is a circle having a radius extending from a center point of the target geographic location, wherein the radius is determined based, at least in part, on the route period.

4. The system of claim 1, wherein the processor is configured to obtain the at least one route object from a route database.

5. The system of claim 4, wherein each route in the route database comprises a pre-generated route, and wherein the at least one route object includes a route area corresponding to the target geographic location and a route period corresponding to the location transition period.

6. The system of claim 4, wherein the at least one route object is selected based, at least in part, on user ranking data for each route object in the route database.

7. The system of claim 1, wherein the set of first selectable objects is identified, at least in part, based on at least one user parameter, wherein the at least one user parameter is a user preference.

8. The system of claim 1, comprising:
controlling a display of the generated data object comprising the at least one route object, the at least one first selectable object, and the at least one second selectable object.

9. A computer-implemented method for generating geographic and time bounded data objects, comprising:
receiving a target geographic location and a location transition period;
obtaining at least one route object based on the target geographic location and the location transition period, wherein the at least one route object includes a set of points of interest;
determining a route between each point of interest in the set of points of interest;
implementing a first geospatial search along the route to identify a set of first selectable objects;
generating a first graphical interface including a graphical representation of the set of points of interest, the route, and the set of first selectable objects;
receiving a selection of at least one first selectable object via the first graphical interface;
implementing a second geospatial search to identify a set of second selectable objects each associated with one of the points of interest;
generating a second graphical interface including a graphical representation of the set of points of interest and the set of second selectable objects;
receiving a selection of at least one second selectable object via the second graphical interface; and
generating a data object comprising the at least one route object, the at least one first selectable object, and the at least one second selectable object.

10. The computer-implemented method of claim 9, wherein obtaining the at least one route object comprises:
determining a route area based on a target geographic location and a route period based on the location transition period;
implementing a third geospatial search to identify a set of points of interest within the route area;
when the set of points of interest includes less than a threshold number of points of interest determined based on the route period:
expanding the route area;
implementing a fourth geospatial search to identify a set of points of interest within the expanded route area;
selecting a subset of the set of points of interest for inclusion in the at least one route object; and
outputting the at least one route object including the subset of the set of points of interest, the route area, and the route period.

11. The computer-implemented method of claim 10, wherein the route area is a circle having a radius extending from a center point of the target geographic location, wherein the radius is determined based, at least in part, on the route period.

12. The computer-implemented method of claim 9, wherein the at least one route object is obtained from a route database.

13. The computer-implemented method of claim 12, wherein each route in the route database comprises a pre-generated route, and wherein the at least one route object includes a route area corresponding to the target geographic location and a route period corresponding to the location transition period.

14. The computer-implemented method of claim 12, wherein the at least one route object is selected based, at least in part, on user ranking data for each route object in the route database.

15. The computer-implemented method of claim 9, wherein the set of first selectable objects is identified, at least in part, based on at least one user parameter, wherein the at least one user parameter is a user preference.

16. The computer-implemented method of claim 9, comprising:
controlling a display of the generated data object comprising the at least one route object, the at least one first selectable object, and the at least one second selectable object.

17. A non-transitory computer-readable medium having instructions stored thereon, wherein the instructions, when executed by at least one processor, cause at least one device to perform operations comprising:
receiving a target geographic location and a location transition period;
obtaining at least one route object based on the target geographic location and the location transition period, wherein the at least one route object includes a set of points of interest;
determining a route between each point of interest in the set of points of interest;
implementing a first geospatial search along the route to identify a set of first selectable objects;
generating a first graphical interface including a graphical representation of the set of points of interest, the route, and the set of first selectable objects;
receiving a selection of at least one first selectable object via the first graphical interface;
implementing a second geospatial search to identify a set of second selectable objects each associated with one of the points of interest;
generating a second graphical interface including a graphical representation of the set of points of interest and the set of second selectable objects;
receiving a selection of at least one second selectable object via the second graphical interface; and
generating a data object comprising the at least one route object, the at least one first selectable object, and the at least one second selectable object.

18. The non-transitory computer-readable medium of claim 17, wherein obtaining the at least one route object comprises:
determining a route area based on a target geographic location and a route period based on the location transition period;
implementing a third geospatial search to identify a set of points of interest within the route area;
when the set of points of interest includes less than a threshold number of points of interest determined based on the route period:
expanding the route area;
implementing a fourth geospatial search to identify a set of points of interest within the expanded route area;
selecting a subset of the set of points of interest for inclusion in the at least one route object; and
outputting the at least one route object including the subset of the set of points of interest, the route area, and the route period.

19. The non-transitory computer-readable medium of claim 18, wherein the route area is a circle having a radius extending from a center point of the target geographic location, wherein the radius is determined based, at least in part, on the route period.

20. The non-transitory computer-readable medium of claim 17, wherein the processor is configured to obtain the at least one route object from a route database, wherein each route in the route database comprises a pre-generated route, and wherein the at least one route object includes a route area corresponding to the target geographic location and a route period corresponding to the location transition period.
